(19) United States
(12) Patent Application Publication
(10) Pub. No.: US 2025/0367760 A1
(43) Pub. Date: Dec. 4, 2025

(54) METHOD FOR LASER WELDING DISSIMILAR METALS TOGETHER AND DISSIMILAR METAL JOINED BODY

(71) Applicant: RYOBI LTD., Fuchu-shi (JP)

(72) Inventors: Shin Nitta, Fuchu-shi (JP); Daisuke Tao, Fuchu-shi (JP); Iori Koga, Fuchu-shi (JP)

(73) Assignee: RYOBI LTD., Fuchu-shi (JP)

(21) Appl. No.: 19/218,887

(22) Filed: May 27, 2025

(30) Foreign Application Priority Data
May 28, 2024 (JP) 2024-086167

(51) Int. Cl. B23K 26/323; F16B 5/08

(52) U.S. Cl. CPC B23K 26/323; F16B 5/08

(57) ABSTRACT

To improve joining strength. Provided is a method for lap welding, with laser, a first member made of a first metal and a second member made of a second metal different from the first metal together. In the method, (a) irradiation with laser is performed from the first member side, (b) the irradiation is performed intermittently while moving the laser, (c) an irradiation direction of the laser is inclined with respect to a direction of overlap of the first member and the second member, and (d) as viewed in the direction of overlap from the first member side, an irradiation direction of the laser at a first irradiation point is a first irradiation direction, and an irradiation direction of the laser at a second irradiation point spaced from the first irradiation point is a second irradiation direction different from the first irradiation direction.

### BACKGROUND

### Technical Field

The present invention relates to a method for laser welding dissimilar metals together and a joined body.

### Related Art

Laser welding dissimilar metals together is more difficult than laser welding pieces of the same kind of metal together. For example, in a case where a member made of iron and a member made of non-ferrous metal such as an aluminum alloy are welded together, it is difficult to achieve sufficient weld strength. When a member made of iron and a member made of an aluminum alloy are overlapped and laser welded together, an intermetallic compound is formed in a bead. Such an intermetallic compound is brittle, and thus it is difficult to achieve sufficient joining strength. JP 2007-136489 A, JP 2012-125829 A, and JP 2014-4619 A made various proposals to ensure sufficient joining strength, such as forming a wedge-shaped bead, but these proposals fail to achieve sufficient joining strength.

### SUMMARY

An object of the present invention is to improve joining strength when joining dissimilar metals together.

A method for laser welding dissimilar metals together according to the present invention is a method for lap welding, with laser, a first member made of a first metal and a second member made of a second metal different from the first metal together. In the method,
(a) irradiation with laser is performed from the first member side,
(b) the irradiation is performed intermittently while moving the laser,
(c) an irradiation direction of the laser is inclined with respect to a direction of overlap of the first member and the second member, and
(d) as viewed in the direction of overlap from the first member side, an irradiation direction of the laser at a first irradiation point is a first irradiation direction, and an irradiation direction of the laser at a second irradiation point spaced from the first irradiation point is a second irradiation direction different from the first irradiation direction.

According to the method, laser irradiation is performed from the first member side, and thus the beads extend from the first member side to the second member side. The irradiation intermittently performed with the moving laser results in formation of spot-shaped beads, and the beads are formed discontinuously at intervals along the movement path of the laser. Furthermore, the irradiation direction of the laser is inclined with respect to the direction of overlap of the first member and the second member (hereinafter simply referred to as the direction of overlap), and thus the bead are formed to extend from the first member side to the second member side in a direction inclined with respect to the direction of overlap. The first irradiation direction at the first irradiation point and the second irradiation direction at the second irradiation point are different from each other. Therefore, the extension direction of the bead extending obliquely from the first member side to the second member side differs between the first irradiation point and the second irradiation point. That is, a first extension direction defined as the extension direction of a first bead formed at the first irradiation point, and a second extension direction defined as the extension direction of a second bead formed at the second irradiation point, are different from each other. Therefore, movement of the second member away from the first member in a direction along the first extension direction, is prevented by the second bead extending in the second extension direction. Furthermore, movement of the second member away from the first member in a direction along the second extension direction, is prevented by the first bead extending in the first extension direction. In this way, the first bead extending in the first extension direction and the second bead extending in the second extension direction cooperate with each other to effectively prevent separation of the first member and the second member, resulting in high joining strength.

In particular, it is preferable that irradiation directions of the laser at adjacent irradiation points are different from each other. That is, by providing the above-mentioned first irradiation point and second irradiation point adjacently to each other and forming the first bead extending in the first extension direction and the second bead extending in the second extension direction adjacently to each other, separation of the first member and the second member are more effectively prevented, and the joining strength is further improved.

Furthermore, it is preferable that irradiation directions of the laser at adjacent irradiation points are different from each other such that the irradiation directions of the laser at the adjacent irradiation points are not aligned in a straight line, as viewed in the direction of overlap from the first member side. A case where irradiation directions of the laser at adjacent irradiation points are aligned in a straight line means a case where the irradiation directions of the laser at the adjacent irradiation points are 0 degree direction and 180 degree direction, respectively, as viewed in the direction of overlap from the first member side. Specifically, such a case includes the following cases:
As illustrated by a combination of part C in FIG. 5, when viewed in the direction of overlap from the first member side as illustrated in FIG. 5, the irradiation direction of the laser at a first one of the irradiation points is toward a second one of the irradiation points, and the irradiation direction of the laser at the second one of the irradiation points is toward the first one of the irradiation points.
As illustrated by a combination of part D in FIG. 5, when viewed in the direction of overlap from the first member side as illustrated in FIG. 5, the irradiation direction of the laser at a first one of the irradiation points is toward the 180 degrees opposite side to a second one of the irradiation points, and the irradiation direction of the laser at the second one of the irradiation points is toward 180 degrees opposite side to the first one of the irradiation points.

In either case, if the irradiation directions of the laser at adjacent irradiation points are aligned in a straight line, the extension directions of the beads formed at the adjacent irradiation points will also be aligned in a straight line as viewed from the first member side. This leads to a risk of cracking along that straight line. For this reason, it is preferable to set the irradiation direction such that the extension directions of beads formed at adjacent irradiation points are not aligned in a straight line as viewed from the first member side.

It is also preferable that a melting point of the first metal is higher than a melting point of the second metal. The laser irradiation from the first member side can ensure melting of the first member with the relatively high melting point, and easy formation of beads extending into the second member.

A dissimilar metal joined body according to the present invention is a dissimilar metal joined body formed by lap welding a first member made of a first metal and a second member made of a second metal different from the first metal together. In the dissimilar metal joined body,
(e) beads are formed to extend from the first member side to the second member side,
(f) spot-shaped beads are discontinuously formed at intervals,
(g) the beads extend from the first member side to the second member side, in a direction inclined with respect to a direction of overlap of the first member and the second member, and
(h) the beads includes a first bead and a second bead, and as viewed in the direction of overlap from the first member side, a direction in which the first bead extends from the first member side to the second member side is a first extension direction, and a direction in which the second bead extends from the first member side to the second member side is a second extension direction different from the first extension direction.

In this configuration, movement of the second member away from the first member in a direction along the first extension direction, is prevented by the second bead extending in the second extension direction. Furthermore, movement of the second member away from the first member in a direction along the second extension direction, is prevented by the first bead extending in the first extension direction. In this way, the first bead extending in the first extension direction and the second bead extending in the second extension direction cooperate with each other to effectively prevent separation of the first member and the second member, resulting in high joining strength.

As described above, the first bead extending in the first extension direction and the second bead extending in the second extension direction cooperate with each other to improve the joining strength.

### BRIEF DESCRIPTION OF THE DRAWINGS

FIG. 1 is a plan view of a part of a joined body according to an embodiment of the present invention, as viewed from a first member side in a direction of overlap,

FIG. 2 is an enlarged view of a part of FIG. 1,

FIG. 3(a) is a cross-sectional view taken along line A-A in FIG. 2, and FIG. 3(b) is a cross-sectional view taken along line B-B in FIG. 2,

FIGS. 4(a) and 4(b) are plan views of a joined body according to another embodiment of the present invention, as viewed from the first member side in the direction of overlap,

FIG. 5 is a plan view of a joined body according to another embodiment of the present invention, as viewed from the first member side in the direction of overlap,

FIGS. 6(a) and 6(b) are plan views of a joined body according to another embodiment of the present invention, as viewed from the first member side in the direction of overlap,

FIG. 7 is a plan view of a joined body according to another embodiment of the present invention, as viewed from the first member side in the direction of overlap,

FIG. 8 is a plan view of a joined body according to another embodiment of the present invention, as viewed from the first member side in the direction of overlap,

FIG. 9 is a plan view of a joined body according to another embodiment of the present invention, as viewed from the first member side in the direction of overlap, and

FIG. 10 is a plan view of a joined body according to another embodiment of the present invention, as viewed from the first member side in the direction of overlap.

### DETAILED DESCRIPTION

Hereinafter, a laser welding method and a joined body according to embodiments of the present invention will be described with reference to the drawings. The joined body is made of metals. The joined body is formed by joining two members each made of a metal together. That is, the joined body includes a first member 1 made of a metal and a second member 2 made of a metal. The joined body is formed by overlapping the first member 1 and the second member 2 and joining the first member 1 and the second member 2 together at predetermined locations to form an integrated body.

In detail, the first member 1 and the second member 2 are made of different metals. Therefore, the joined body is a joined body of dissimilar metals. The first member 1 is made of a first metal. The second member 2 is made of a second metal different from the first metal. The first metal has a first melting point. The second metal has a second melting point. The first melting point is higher than the second melting point. Various types of metals may be used for the first member 1 and the second member 2. Typically, the first member 1 is made of iron or steel and the second member 2 is made of an aluminum alloy. The first member 1 and the second member 2 may each be in a variety of forms. For example, the first member 1 may be a plate material, and the second member 2 may be a cast material such as a die-cast material.

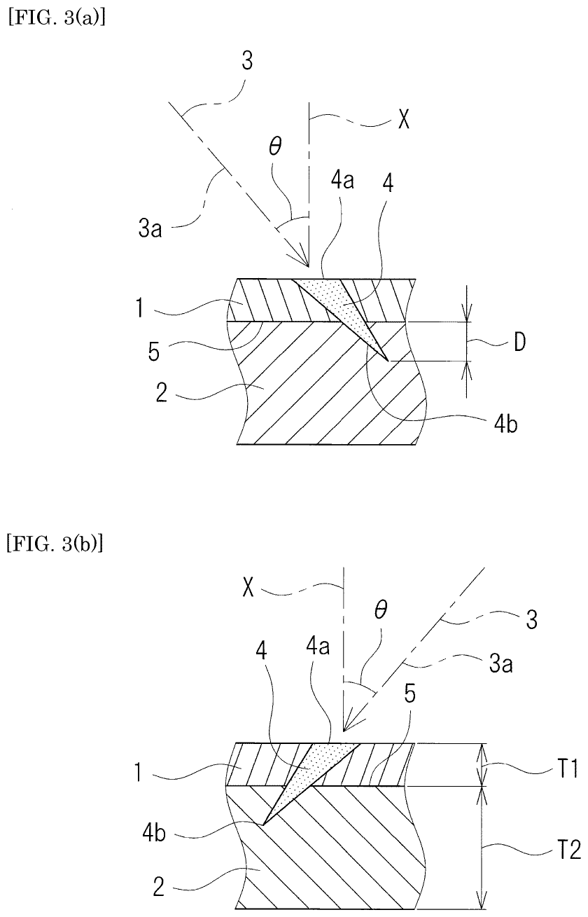

The first member 1 and the second member 2 are welded together using a laser. That is, the joining method is laser welding. As illustrated in FIG. 3, irradiation with the laser 3 is performed from the first member 1 side. In the present embodiment, the thickness T1 of the first member 1 is less than the thickness T2 of the second member 2. By irradiating the first member 1 with the laser 3, the first member 1 having a higher melting point melts first, and then the second member 2 having a lower melting point melts. As a result, a bead 4 (weld bead) is formed. In the drawings, the bead 4 is indicated by a number of dots.

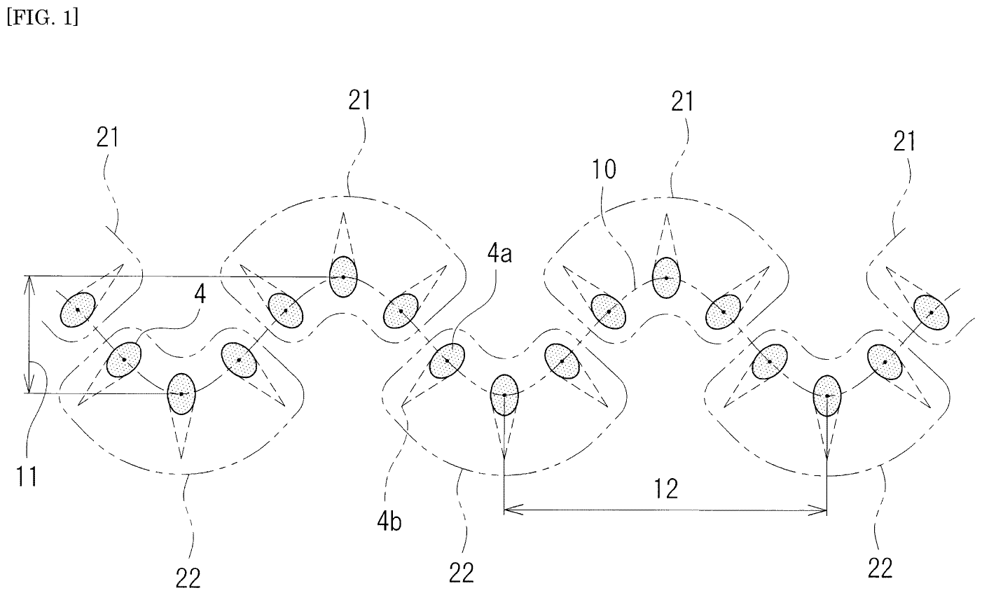

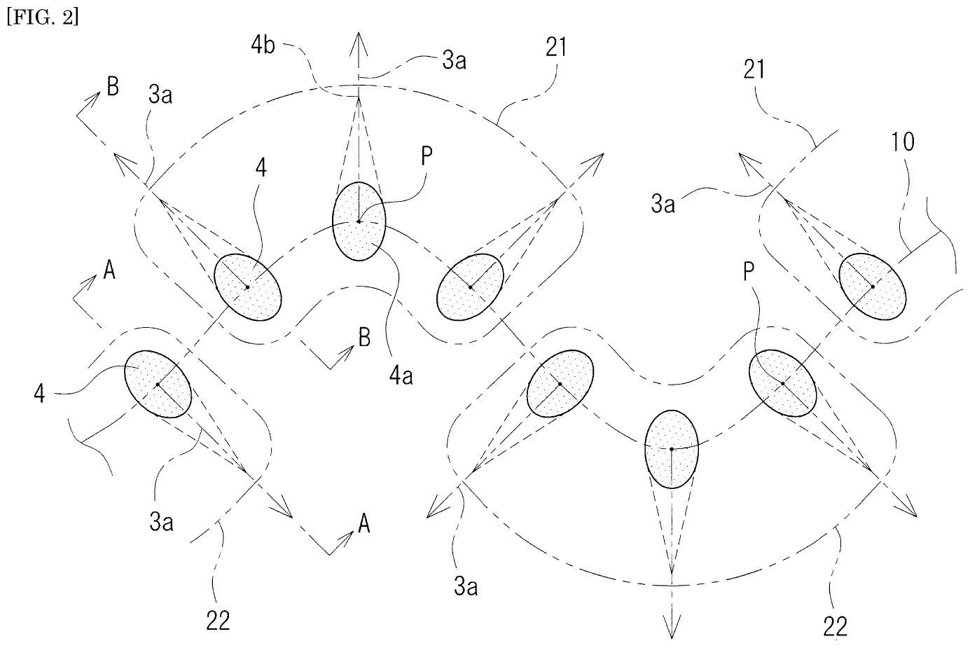

The laser 3 (torch) is moved along a joint portion. Any movement path such as a straight path may be used as a movement path 10 of the laser 3. In the present embodiment, as illustrated by a dash-dot-dot line in FIGS. 1 and 2, in a plan view of the joined body seen from the first member 1 side in a direction of overlap X, the movement path 10 of the laser 3 has a waveform that vibrates left and right with respect to a predetermined direction (sine curve) and the waveform has a predetermined amplitude 11. Any amplitude and any wavelength can be used as the amplitude 11 and the wavelength 12 of the waveform, respectively. The movement path 10 is a line that connects the centers of base ends 4a of the beads 4 in a plan view.

Irradiation with the laser 3 is performed intermittently, instead of being performed continuously. Specifically, irradiation with the laser 3 is performed intermittently while moving the laser 3 along the predetermined movement path 10. As a result, the spot-shaped beads 4 are formed at intervals along the movement path 10 of the laser 3, as illustrated in FIGS. 1 and 2, instead of being formed in a continuous line along the movement path 10 of the laser 3. The beads 4 form a dashed line along the movement path 10. The intervals between adjacent beads 4 may be constant or may vary. In the present embodiment, the interval between adjacent beads 4 is constant. Irradiation points of the laser 3 are set at regular intervals along the movement path 10 of the laser 3, and the beads 4 are formed at regular intervals along the movement path 10 of the laser 3.

The bead 4 has a wedge shape. The bead 4 has the base end 4a on the first member 1 side and a tip end 4b on the second member 2 side, and has a tapered shape that is tapered toward the tip end 4b. In the drawings, the shape of the bead 4 is simplified and illustrated as a cone shape. The bead 4 passes through an interface 5 between the first member 1 and the second member 2 and extends into the second member 2, but does not extend through the second member 2. Therefore, the bead 4 is non-through bead. It is preferable that the bead 4 in the second member 2 reaches a depth substantially equal to the thickness T1 of the first member 1. That is, a reached depth D that the bead 4 in the second member 2 reaches (depth in the direction of overlap X) is preferably equal to or greater than the thickness T1 of the first member 1. The reached depth D is a depth in the direction of overlap X, and is a dimension in the direction of overlap X and from the interface 5 to the tip end 4b of the bead 4.

The first member 1 is irradiated with the laser 3 obliquely, rather than perpendicularly. That is, an irradiation direction 3a of the laser 3 is inclined with respect to the direction of overlap X. In FIG. 3, in a cross-sectional view, the inclination angle of the irradiation direction 3a of the laser 3 with respect to the direction of overlap X is indicated as θ. The inclination angle θ is preferably from 10 to 80 degree, and more preferably from 20 to 70 degree, and yet more preferably from 30 to 75 degree. As illustrated in FIGS. 1 and 2, the irradiation direction 3a of the laser 3 in a plan view is not fixed, but changes along the movement path 10 of the laser 3. Such changing of the irradiation direction 3a may be implemented in any manner. Preferably, the irradiation directions 3a of the laser 3 at adjacent irradiation points P in a plan view are different from each other. In a plan view, a first irradiation direction 3a of the laser 3 at a first irradiation point P is different from a second irradiation direction 3a of the laser 3 at a second irradiation point P adjacent to the first irradiation point P. In FIG. 2, the irradiation direction 3a of the laser 3 at each irradiation point P in a plan view is indicated by an arrow illustrated with a dash-dot line. The irradiation direction 3a of the laser 3 in a plan view is a direction from the center of the bead 4 at the surface of the first member 1 (the center of the base end 4a of the bead 4) toward the tip end 4b of the bead 4. The bead 4 extends from the first member 1 side to the second member 2 side along the irradiation direction 3a of the laser 3, and thus the irradiation direction 3a of the laser 3 is the extension direction of the bead 4.

Any degree of change may be used as a change from the first irradiation direction 3a at the first irradiation point P to the second irradiation direction 3a at the second irradiation point P. In the present embodiment, irradiation directions are reversed in the left-right direction with respect to the movement path 10 of the laser 3, on a group-by-group basis. Specifically, there is a first group 21 associated with the irradiation directions 3a of the laser 3 (extension directions of the beads 4) toward a left-right first side with respect to the travel direction of the laser 3 in a plan view, and a second group 22 associated with the irradiation directions 3a of the laser 3 toward a left-right second side with respect to the travel direction of the laser 3, that is opposite to a left-right first side. The first group 21 includes a plurality of irradiation points P. That is, the first group 21 includes a plurality of beads 4. Similarly, the second group 22 includes a plurality of irradiation points P and includes a plurality of beads 4.

The first group 21 and the second group 22 are alternately arranged. The first group 21 may include any number of the irradiation points P and beads 4, and the second group 22 may include any number of the irradiation points P and beads 4. In the present embodiment, the number of irradiation points P and beads 4 in the first group 21 and the number of irradiation points P and beads 4 in the second group 22 are the same, and in an example, are both three. In addition, in the present embodiment, at each irradiation point P, the irradiation direction 3a of the laser 3 is inclined at a right angle or an angle close to a right angle with respect to the movement path 10 of the laser 3 in a plan view. Therefore, in a plan view, the irradiation direction 3a of the laser 3 at each irradiation point P is not along the movement path 10 of the laser 3, and the irradiation directions 3a of the laser 3 at adjacent irradiation points P are not aligned in a straight line. In the present embodiment, the irradiation direction 3a of the laser 3 is substantially perpendicular to the movement path 10 of the laser 3 in a plan view. However, the irradiation direction 3a may not be substantially perpendicular to the movement path 10, and in such a case, it is preferable that the irradiation direction 3a is inclined at a predetermined angle with respect to the movement path 10 of the laser 3 in a plan view.

The transition from the first group 21 to the second group 22, and the transition from the second group 22 to the first group 21 involve 180 degree reversal of the irradiation directions 3a of the laser 3 and the extension directions of the bead 4 of adjacent irradiation points P in a plan view. Furthermore, in each group, the irradiation direction 3a of the laser 3 in a plan view changes sequentially. In the first group 21, the irradiation direction 3a of the laser 3 in a plan view gradually changes along the movement path 10 of the laser 3, and also in the second group 22, the irradiation direction 3a similarly changes.

As described above, in the present embodiment, irradiation with the laser 3 is performed from the first member 1 side. Therefore, the first member 1 having a higher melting point can be surely melted, and the bead 4 extending into the second member 2 can be easily formed. Furthermore, the movement path 10 of the laser 3 is not straight but wavy, and thus the welded portion can be wide in accordance with the predetermined amplitude 11, which makes it easier to increase the joining strength. In addition, spot-shaped beads 4 are formed by intermittent irradiation with the laser 3, and the extension direction of the bead 4 in a plan view is sequentially changed along the movement path 10 of the laser 3. Multiple beads 4 with different extension directions cooperate with each other to prevent separation of the first member 1 and the second member 2. Therefore, a high joining strength can be achieved. In particular, since adjacent beads 4 have different extension directions, the adjacent beads 4 can cooperate with each other to prevent separation of the members. Thus, the joining strength can be further increased. Furthermore, the extension directions of the beads 4 with respect to the movement path 10 are reversed in the left-right direction on a group-by-group basis (i.e., the first group 21 and the second group 22). This makes it easier to control the torch angle compared to the case where the extension directions are reversed in the left-right direction on a bead-4-by-bead-4 basis.

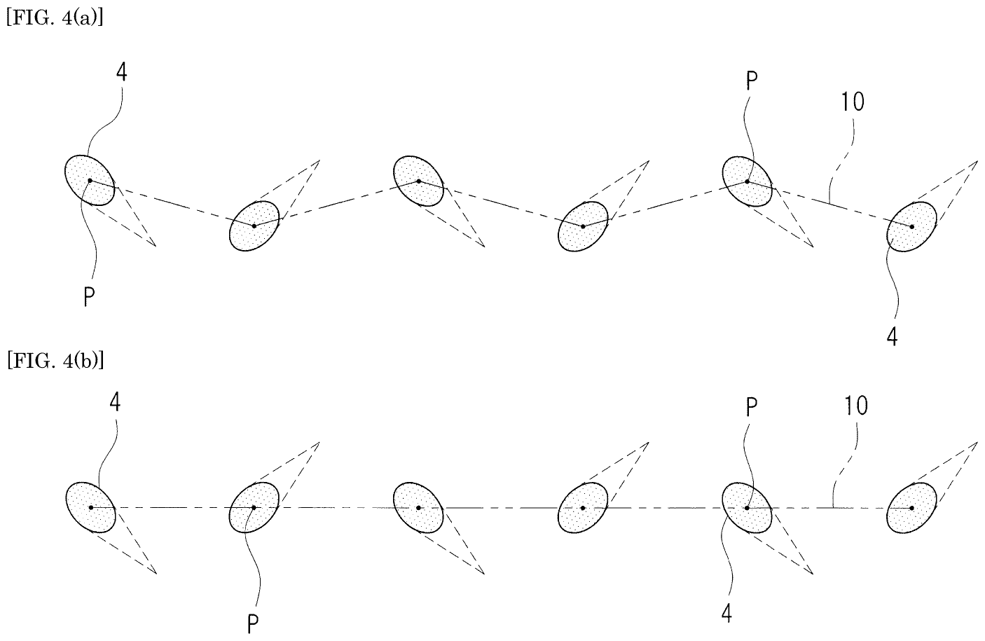

However, such groups may not be formed, and as illustrated in FIG. 4, the extension direction of the bead 4 (the irradiation direction 3a of the laser 3) with respect to the movement path 10 may be reversed in the left-right direction on a bead-4-by-bead-4 basis. In a joined body illustrated in FIG. 4, the extension directions of the beads 4 are alternately reversed in the left-right direction along the movement path 10. The movement path 10 in FIG. 4(a) is zigzag rather than straight, and the movement path 10 in FIG. 4(b) is straight. When the movement path 10 is straight, the base ends 4a of the beads 4 are formed to be arranged in a straight line at intervals. Furthermore, the extension directions of the beads 4 are not perpendicular to the movement path 10, and are inclined at an inclination angle less than 90 degrees. The extension directions of all the beads 4 are toward the forward side or backward side of the moving direction of the laser 3. Therefore, control of the inclination angle of the torch can be easily performed.

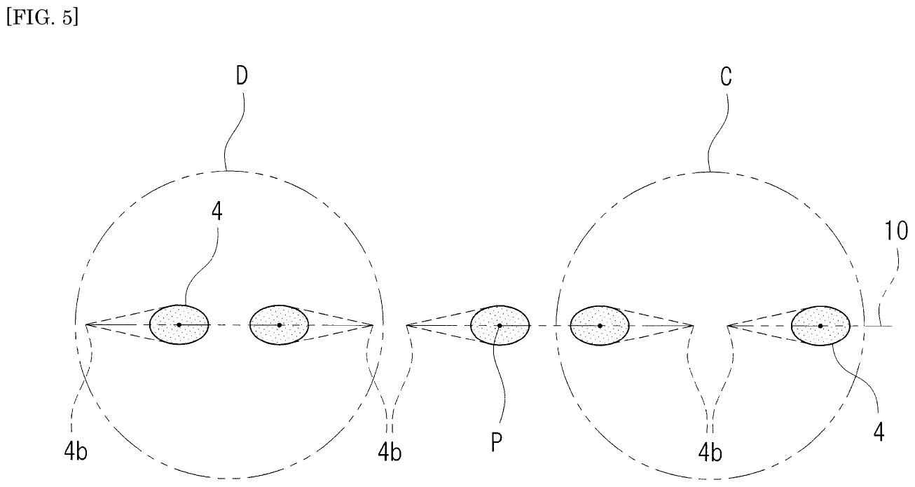

The extension directions of adjacent beads 4 may be aligned in a straight line in a plan view. For example, in FIG. 5, the movement path 10 is straight, and the extension directions of the beads 4 are along the movement path 10. In part C of FIG. 5, the tip ends 4b of adjacent beads 4 face each other. In part D of FIG. 5, the tip ends 4b of adjacent beads 4 face in opposite directions. In a plan view, the extension directions of the beads 4 are not inclined with respect to the movement path 10 but are along the movement path 10.

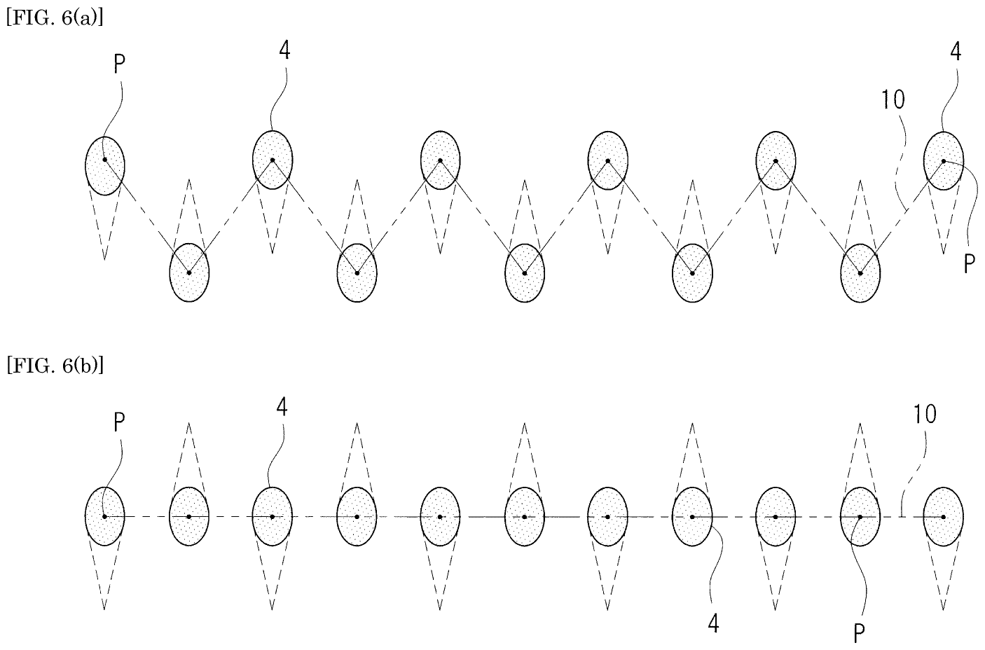

As illustrated in FIG. 6(a), the movement path 10 may be formed in a zigzag shape, and the extension direction of the bead 4 may be alternately reversed 180 degrees in the left-right direction with respect to the movement path 10. As illustrated in FIG. 6(b), the movement path 10 may be straight rather than zigzag.

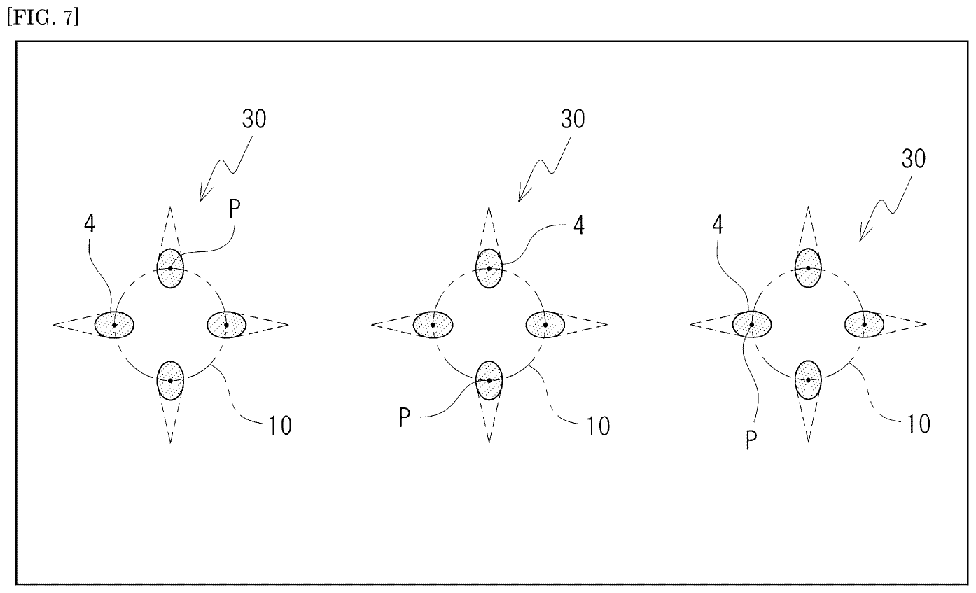

The beads 4 may be formed radially. For example, as illustrated in FIG. 7, radial array groups 30 each including a plurality of beads 4 radially arranged may be arranged at intervals along a predetermined direction. In this case, the movement path 10 of the laser 3 for each of the radial array groups 30 is circular, and the irradiation points P are positioned on each circle at predetermined angular intervals. A plurality of radial array groups 30 are provided at intervals along a predetermined direction. Although the radial array group 30 in the embodiment includes four beads 4, the radial array group 30 may include any number of beads. The four beads 4 are arranged in a cross shape on the same circle. That is, the beads 4 are provided at 90 degree intervals, and are arranged at the 0 degree position, the 90 degree position, the 180 degree position, and the 270 degree position, respectively. In the radial array group 30, the extension direction of each bead 4 is not toward the center of the cross but toward the outside in the cross direction. That is, the extension directions of all the beads 4 are toward a radial outside, and in a plan view, the base ends 4a of the beads 4 are located radially inward, and the tip ends 4b of the beads 4 are located radially outward.

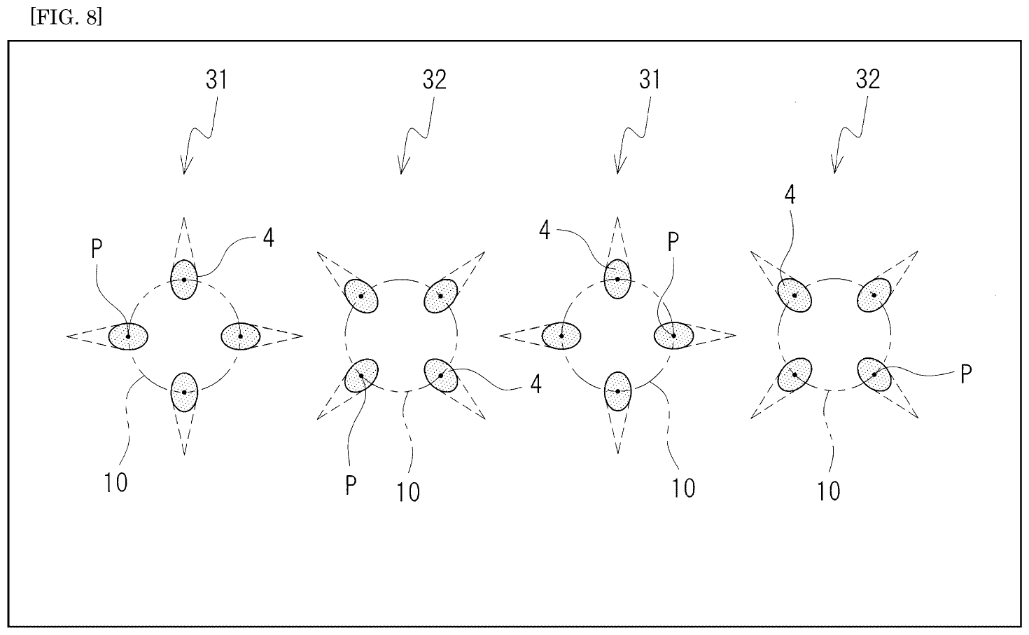

As illustrated in FIG. 8, a plurality of types, for example two types of radial array groups 30 may be provided. The two types of radial array groups 30 may be arranged alternately. For example, a first radial array group 31 with a cross shape formed by the beads 4 arranged at the 0 degree position, the 90 degree position, the 180 degree position, and the 270 degree position, and a second radial array group 32 with a cross shape formed by the beads 4 arranged at the 45 degree position, the 135 degree position, the 225 degree position, and the 315 degree position may be provided, and the first radial array groups 31 and the second radial array groups 32 may be alternately arranged in a row in a predetermined direction at regular intervals.

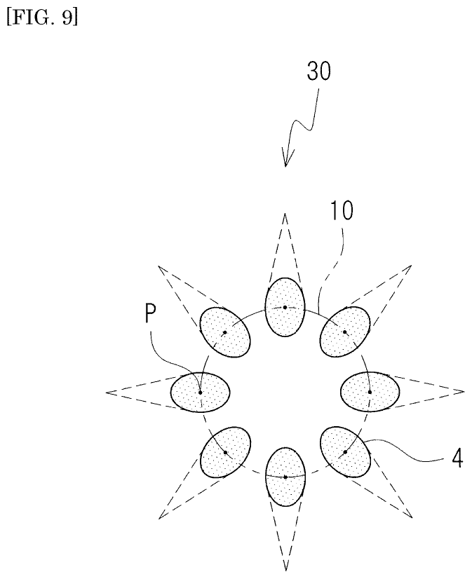

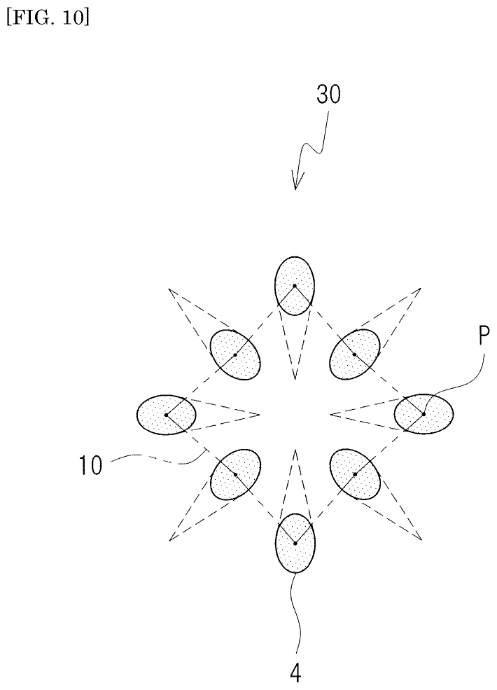

The radial array group 30 may include any number of beads 4, and for example, as illustrated in FIG. 9, eight beads 4 may be arranged on the same circle at 45 degree intervals. Furthermore, instead of all of the extension directions of the beads 4 in the radial array group 30 being toward a radial outside in a plan view, as in FIGS. 7 to 9, the beads 4 having radially outward extension directions and the beads 4 having radially inward extension directions may be mixed. For example, as illustrated in FIG. 10, the bead 4 having a radially outward extension direction and the bead 4 having a radially inward extension direction may be alternately arranged in the circumferential direction. Furthermore, instead of all the irradiation points P being arranged on the same circle, for example, four irradiation points P arranged on a first circle and four irradiation points P arranged on a second circle having a different diameter from the first circle may be provided.

1. A method for laser welding, comprising:
providing a first member made of a first metal and a second member made of a second metal such that the first member is overlapped with the second member to define an overlapping direction;
irradiating the first member with a laser at a first irradiation point at a first angle of the laser and at a first irradiation direction, wherein the first angle of the laser is with respect to the overlapping direction and inclined with respect to the overlapping direction;
moving the laser without irradiating the first member;
irradiating the first member with the laser at a second irradiation point at a second angle of the laser at a second irradiation direction, wherein the second angle of the laser is with respect to the overlapping direction and inclined with respect to the overlapping direction, the second angle same as or different from the first angle,
wherein the second irradiation direction is different from the first irradiation direction.

2. The method for laser welding according to claim 1, wherein the second irradiation point is adjacent to the first irradiation point without another irradiation point therebetween.

3. The method for laser welding according to claim 2, wherein the first irradiation direction and the second irradiation direction are not aligned in a straight line.

4. The method for laser welding according to claim 1, wherein a melting point of the first metal is higher than a melting point of the second metal.

5. The method for laser welding according to claim 1, wherein the overlapping direction corresponds to a direction perpendicular to a surface of the first member.

6. The method for laser welding according to claim 1, wherein the first member has a thickness smaller than the second member.

7. The method for laser welding according to claim 1, wherein when the first member is irradiated with the laser, the first member is first melt followed by melting the second member to form a bead.

8. The method for laser welding according to claim 1, wherein the first angle is from 10 to 80 degree, and the second angle is from 10 to 80 degree.

9. The method for laser welding according to claim 1, wherein the first metal is different in kind from the second metal.

10. A metal joined body, comprising:
a first member made of a first metal;
a second member made of a second metal different from the first metal together, the second member joined with the first member by lap welding;
a first bead formed to extend from the first member to the second member at a first extension direction; and
a second bead formed to extend from the first member to the second member at a second extension direction,
wherein the first bead is separately formed from the second bead, and the first extension direction is different from the second extension direction.
